(19) United States
(12) Patent Application Publication
(10) Pub. No.: US 2017/0120329 A1
(43) Pub. Date: May 4, 2017

(54) Process for Making Nickel-Based Superalloy Articles by Three-Dimensional Printing

(71) Applicant: The ExOne Company, North Huntingdon, PA (US)

(72) Inventors: Michael J. Orange, Latrobe, PA (US); Howard A. Kuhn, Butler, PA (US); Paul P. Knor, Ruffsdale, PA (US); Thomas Lizzi, Harmony, PA (US)

(21) Appl. No.: 15/314,120

(22) PCT Filed: May 26, 2015
(86) PCT No.: PCT/US2015/032408

§ 371 Date: Nov. 28, 2016

Related U.S. Application Data
(60) Provisional application No. 62/004,508, filed on May 29, 2014.

(51) Int. Cl. B22F 3/10; B33Y 10/00; F01D 5/28; B22F 9/08; B22F 5/04; B33Y 80/00; B33Y 70/00

(52) U.S. Cl. CPC B22F 3/1035; B33Y 80/00; B33Y 10/00; B33Y 70/00; B22F 9/082; B22F 3/1017; B22F 5/04; F01D 5/28; B22F 2009/0828; B22F 2301/15; B22F 2998/10; B22F 2304/10; F05D 2230/22; F05D 2300/177; F05D 2300/175

(57) ABSTRACT

Methods are presented for making sintered articles from water-atomized nickel-based superalloy powders. Three-dimensional binder jet printing is used to make a printed article from the powder. The printed article is liquid phase sintered without slumping at a temperature at which at least fifteen volume percent of the powder is liquid during sintering.

### BACKGROUND

Field of the Invention: The present invention relates to a process for making nickel-based superalloy articles by three-dimensional printing.

Background of the Art: Nickel-based superalloys are used to make components for use in many aerospace, chemical, power, and industrial applications that require good corrosion resistance, and/or high temperature strength and/or creep resistance. Conventionally, nickel-based superalloys articles are made by casting, by casting-plus-wrought processes, or by powder metallurgy techniques involving loading a powder into a mold and then hot isostatically pressing the mold to densify the powder. Often, a significant amount of material loss is incurred, e.g. by machining processes, in creating the article.

Recently, nickel-based superalloy articles have been made by the three-dimensional laser sintering process and by the three-dimensional electron beam melting process. Each of these processes involves making the article a layer at time by melting together the powder on each layer into a pattern that corresponds to a slice of the finished article. These processes must be conducted in protective atmospheres and involve the use of high energy sources to accomplish the localized melting by which the powder particles are fused together on each layer and between layers.

A simpler, less expensive, and much higher throughput process for making nickel-based superalloy parts from powder is the three-dimensional binder jet printing process. This process is also sometimes called the “three-dimensional inkjet printing process” because the binder jetting is done using a print head that resembles those developed for inkjet printing, or more simply “three-dimensional printing.” For conciseness, the latter term will be used hereinafter. Like the laser and e-beam three-dimensional processes described above, three-dimensional printing involves making an article a layer at a time from powder. However, it differs from those processes in that it does not fuse the powder together with a high-energy source, but rather adheres the particles together by way of a deposited binder. It also differs from those processes in that it can be done in air, thus obviating the need for expensive protective atmospheric chambers and their associated hardware and gas supplies.

After a powder version of the article is made by the three-dimensional printing process, the powder version is then heated to sinter the powder together to transform the powder version into the article itself. Conventionally, it has been found necessary in order to achieve a high density article to liquid phase sinter the powder version of the article near or at the solidus temperature of the nickel-base superalloy, sometimes with a very low amount of liquid phase present. However, employing too high of a sintering temperature causes geometrical distortion of the article (sometimes referred to as slumping) due to the presence of too much liquid phase, the amount of which increases dramatically as the sintering temperature increases.

Improvements are still desired for making nickel-based superalloy articles by three-dimensional printing, especially those improvements which would result in lowered costs. Up until now, only nickel-based superalloy powders which were made by a relatively low oxygen process of gas atomization were able to be sintered together into a high density, low porosity article from the powder version of article. Although the use of lower cost water-atomized nickel-based superalloy powders was desirable to lower costs, powder versions of articles made from such powders had low densities and so were not suitable for many applications.

### SUMMARY OF THE INVENTION

The inventors of the present invention have made the surprising discovery that it is possible to make high density nickel-based superalloy articles from water-atomized nickel-based superalloy powders by using the three-dimensional binder jetting printing process to form a powder version of the article and then liquid phase sintering the powder version at temperatures at which a relatively large amount of liquid phase is present—an amount which would have been considered by those skilled in the art to be inconsistent with avoiding slumping of the article. Accordingly, the present invention presents methods which include the steps of providing a water-atomized nickel-based superalloy powder; depositing a layer of the powder; ink jet depositing a binder onto the layer in a pattern that corresponds to a slice of the article; repeating the previous two steps for additional layers of the powder and additional patterns, each of which additional patterns corresponds to an additional slice of the article, until a powder version of the article is completed; liquid phase sintering the powder version of the article at a temperature at which at least fifteen volume percent of the powder of the powder version of the article is liquid so as to transform the powder version of the article into the article without slumping; and cooling the article to solidify the article.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 a schematic vertical cross section of the bottom section of a powder dispenser, sans roller, in accordance with an embodiment of the present invention.

FIG. 2 is a photograph of rotor fin articles of Example 1 made from water-atomized IN 625 powder in accordance with an embodiment of the present invention.

FIG. 3 is a photograph of a severely slumped rectangular block of Example 4 made from gas-atomized IN 625 powder.

### DESCRIPTION OF PREFERRED EMBODIMENTS

In this section, some preferred embodiments of the present invention are described in detail sufficient for one skilled in the art to practice the present invention without undue experimentation. It is to be understood, however, that the fact that a limited number of preferred embodiments are described herein does not in any way limit the scope of the present invention as set forth in the claims. It is to be understood that whenever a range of values is described herein or in the claims that the range includes the end points and every point therebetween as if each and every such point had been expressly described. Unless otherwise stated, the word “about” as used herein and in the claims is to be construed as meaning the normal measuring and/or fabrication limitations related to the value which the word “about” modifies. Unless expressly stated otherwise, the term “embodiment” is used herein to mean an embodiment of the present invention.

The basic three-dimensional printing process was developed in the 1990's at the Massachusetts Institute of Technology and is described in several United States patents, including the following U.S. Pat. No. 5,490,882 to Sachs et al., U.S. Pat. No. 5,490,962 to Cima et al., U.S. Pat. No. 5,518,680 to Cima et al., U.S. Pat. No. 5,660,621 to Bredt et al., U.S. Pat. No. 5,775,402 to Sachs et al., U.S. Pat. No. 5,807,437 to Sachs et al., U.S. Pat. No. 5,814,161 to Sachs et al., U.S. Pat. No. 5,851,465 to Bredt, U.S. Pat. No. 5,869,170 to Cima et al., U.S. Pat. No. 5,940,674 to Sachs et al., U.S. Pat. No. 6,036,777 to Sachs et al., U.S. Pat. No. 6,070,973 to Sachs et al., U.S. Pat. No. 6,109,332 to Sachs et al., U.S. Pat. No. 6,112,804 to Sachs et al., U.S. Pat. No. 6,139,574 to Vacanti et al., U.S. Pat. No. 6,146,567 to Sachs et al., U.S. Pat. No. 6,176,874 to Vacanti et al., U.S. Pat. No. 6,197,575 to Griffith et al., U.S. Pat. No. 6,280,771 to Monkhouse et al., U.S. Pat. No. 6,354,361 to Sachs et al., U.S. Pat. No. 6,397,722 to Sachs et al., U.S. Pat. No. 6,454,811 to Sherwood et al., U.S. Pat. No. 6,471,992 to Yoo et al., U.S. Pat. No. 6,508,980 to Sachs et al., U.S. Pat. No. 6,514,518 to Monkhouse et al., U.S. Pat. No. 6,530,958 to Cima et al., U.S. Pat. No. 6,596,224 to Sachs et al., U.S. Pat. No. 6,629,559 to Sachs et al., U.S. Pat. No. 6,945,638 to Teung et al., U.S. Pat. No. 7,077,334 to Sachs et al., U.S. Pat. No. 7,250,134 to Sachs et al., U.S. Pat. No. 7,276,252 to Payumo et al., U.S. Pat. No. 7,300,668 to Pryce et al., U.S. Pat. No. 7,815,826 to Serdy et al., U.S. Pat. No. 7,820,201 to Pryce et al., U.S. Pat. No. 7,875,290 to Payumo et al., U.S. Pat. No. 7,931,914 to Pryce et al., U.S. Pat. No. 8,088,415 to Wang et al., U.S. Pat. No. 8,211,226 to Bredt et al., and U.S. Pat. No. 8,465,777 to Wang et al.

In essence, three-dimensional printing involves the spreading of a layer of a particulate material and then selectively inkjet-printing a fluid onto that layer to cause selected portions of the particulate layer to bind together. This sequence is repeated for additional layers until the desired part has been constructed. The material making up the particulate layer is often referred as the “build material” or the “build material powder” and the jetted fluid is often referred to as a “binder”, or in some cases, an “activator”. During the process, the portions of the powder layers which are not bonded together with the binder form a bed of supporting powder around the article or articles which are being made, i.e. a “powder bed” or “build bed.”

Post-build processing of the three-dimensionally printed article, i.e., the powder version of the article, is often required in order to strengthen and/or densify the part. Often, the first post-processing step will be to heat the powder version of the article while it is still supported by the powder bed to cure the binder, followed by a second step of removing the powder version of the article from the powder bed, and a third step of heat treating the powder version of the article to sinter together the powder particles of the powder version. For example, when metal powders are used as the build material, the post-processing sometimes involves sintering the metal powder together and/or infiltrating the sintered but porous article with a lower-melting temperature metal.

In embodiments, a water-atomized nickel-based superalloy powder is provided in quantities sufficient to produce the article or articles desired, taking into account the three-dimensional printing machine that is to be used and the size of the powder bed that will surround the powder version of the article. The first layer of powder is spread onto a vertically indexible platform. An image or pattern corresponding to a first layer of the article or articles to be built may be imparted to this layer by inkjet printing binder onto this layer or one or more additional layers may be deposited before the first pattern is imparted. The process of depositing a powder layer followed by imparting an additional image which corresponds to an additional slice of the article or article is continued until the powder version of the article or articles are completed. For conciseness, the powder version of an article is often referred to herein as the “printed article”.

In embodiments in which the binder used in the inkjet printing requires curing in order to provide the printed article or articles with strength sufficient for handling, a curing process is conducted on the printed article or articles. Whether or not a curing step is used, the printed article or articles subsequently are removed from the powder bed and cleaned of all unwanted adhering or captured powder. The printed article or articles may then be heat treated to densify them by sintering.

The heat treating must be done in a controlled atmosphere which essentially excludes the presence of air. The atmosphere may be any atmosphere which is suitable for sintering nickel-based superalloys, e.g. argon, vacuum, hydrogen, etc. Preferably, the atmosphere has a dew point of less than minus 50° C. During the heating of the printed article or articles, accommodations may be made for the removal or dissociation of the binder from the printed article or articles. The heat treatment includes holding the printed article or articles at a temperature that is sufficiently above the solidus of the nickel-based superalloy to melt at least fifteen volume percent of the powder of the printed article or articles into a liquid phase. Those skilled in the art will recognize that such high liquid volume levels would be expected to cause significant slumping. However, the inventors have made the surprising discovery that water-atomized nickel-based superalloy powder printed articles made in accordance with the present invention can be liquid phase sintered at such temperatures without slumping. Nonetheless, if the sintering temperature is further increased, there comes a point at which slumping does occur.

It is within scope of the present invention that the printed article be sintered without slumping at a temperature at which at least twenty volume percent of the powder of the printed article is liquid. It is also within scope of the present invention that the printed article be sintered without slumping at a temperature at which at least thirty volume percent of the powder of the printed article is liquid. It is likewise within scope of the present invention that the printed article be sintered without slumping at a temperature at which at least forty volume percent of the powder of the printed article is liquid.

Without intending to be bound, the inventors suggest that this surprising result is due to the character of the coatings on the surface of water-atomized nickel-based superalloy powders which form during the water atomization process. As indicated below in the comparative examples, attempts to sinter nickel-based superalloys made by the relatively low-oxygen process of gas atomization result in gross slumping at comparatively low liquid volume fraction levels. The inventors believe that the coatings on the surfaces of the water-atomized nickel-based superalloy powder particles act to contain the liquid phase of each powder particle until a point is reached at which the hydrostatic pressure of the liquid phase cracks the coatings. When this cracking occurs, a portion of the liquid is able to escape from its originating powder particle and to come into contact with the liquid from other powder particles to create an interparticulate liquid surface tension sufficient to densify the printed article to a high density. Additionally or alternatively, again without intending to be bound, the inventors suggest that the surprising result is contributed to or accounted the coatings producing an increase in the effective viscosity of the liquid phase during sintering.

In embodiments, it is preferred that the relative density of the sintered article, i.e. the density of the sintered article expressed as a percentage of the theoretical density for the nickel-base superalloy comprising the article, is in the range of between 92% and 100%. More preferably, the range is between 96% and 100%.

Nickel-based superalloys have a microstructure in which nickel is the solvent for a solid solution consisting of nickel and other elements, e.g. chromium, molybdenum, iron, etc., which together form a malleable, tough, temperature-omnipresent face-centered cubic phase, which is often referred to as the gamma phase. These alloys also contain a second phase, often referred to as a gamma prime phase, which has the general composition of Ni₃ (Ti, Al) and has a face-centered cubic crystal structure. Some nickel-based superalloys also include a third phase, which is often referred to as gamma double prime, which has the general composition of Ni₃Nb and has a body-centered tetragonal crystal structure. Some nickel-based superalloys may contain carbides, carbonitrides, or oxides. Examples of nickel-based superalloys include Astroloy, C-1023, CMSX-11B, CMSX-11C, GMR-235, Hastalloy X, Illium G, Inconel 690, Inconel 718, Inconel 713C, Inconel 738, Inconel 625, Inconel 617, Inconel 690, Inconel X-750, Inconel 939, M-252, MAR-M 421, Rene 41, Rene 77, Rene 80, SEL, Udimet 500, Udiment 700, Udiment 710, Waspalloy, and WAX-20.

In embodiments, it is preferable that the average particle size of the powder be less than about 60 microns; more preferably that it be less than 30 microns; and even more preferably that it be under 20 microns. Powder size distributions which enable some smaller particles to fill in the voids between the larger particles are preferred. It is also preferred that the powder distribution contain no particles having a size which is greater than a third of layer thickness that is to be used in the three-dimensional printing process.

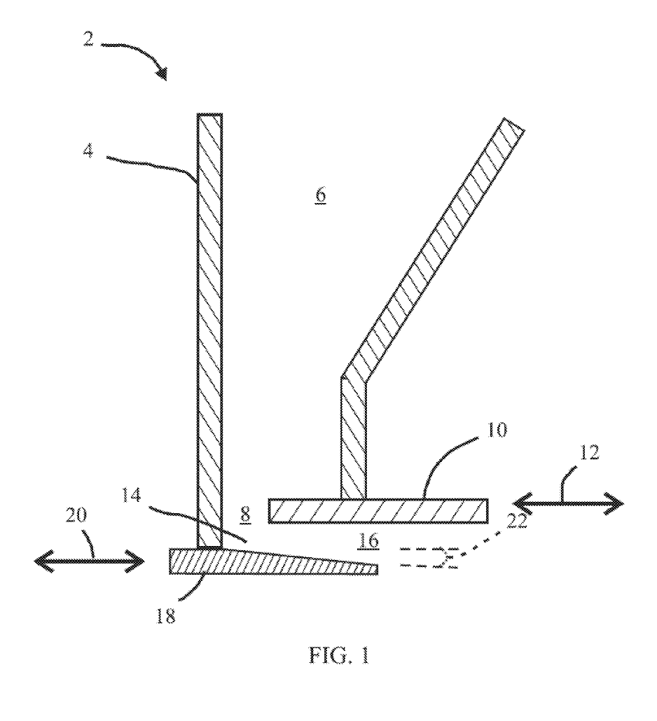

The powders may be deposited as layers using conventional spreading mechanisms. However, when using powders under 30 microns average particle size, there may be a tendency of the powder to poorly spread into uniform layers. In such cases, it is preferred to use a powder dispenser having a beveled foot member in conjunction with a counter-rotating roller to smooth out the powder into a uniform layer. The roller and the powder dispenser may be supported by a common carriage or by separate carriages for moving them across the area on which the powder layer is to be spread. Preferably, the roller is attached to the powder dispenser. FIG. 1 schematically shows a vertical cross section of the bottom section of such a powder dispenser, sans roller.

Referring to FIG. 1, the powder dispenser 2 is movably supported by a carriage (not shown) for selectively moving it above and across a powder bed (not shown). The powder dispenser 2 includes a tapered hopper 4 having a reservoir section 6 for receiving and holding a predetermined amount of the powder that is to be deposited. The lower portion of the hopper 4 includes an adjustable throat 8, the width of which is selectively determined by the position of a fixedly adjustable plate 10. The plate 10 is movably supported by supporting slots at its ends and its center (not shown) which are operably connected to the hopper 4. The plate 10 may be selectively moved inward or outward (as indicated by the arrow 12) to adjust the width of the throat 8 and then releaseably locked into place by a locking mechanism (not shown). The hopper 4 also has a powder dispensing section 14. The dispensing section 14 has a mouth 16 which substantially extends along the width of the hopper 4 and a beveled bottom foot or plate 18 which helps to define the lower edge of the mouth 16. The bottom plate 18 is supported by unshown connecting means to the hopper 4 so as to be lockably positionable in the directions of arrow 20 so as to controllably adjust the distance the powder travels across its top face and also the opening height of the mouth 16. Preferably, the plate 10 is also adapted to be moved upward or downward so as to adjust the opening height of mouth 10. The bevel angle 22 which the top face of the bottom plate 18 makes from the horizontal is within the range of 5 to 45 degrees, and more preferably within the range of 5 to 25 degrees, and even more preferably within the range of 10 to 15 degrees. Preferably, the bottom plate 18 is adapted to be easily interchangeable so that a bottom plate 18 having the desired bevel angle for a given powder can be interchanged with one having a less desirable bevel angle.

During operation of the powder dispenser 2, powder is loaded into and stored within the reservoir 6 of the hopper 4. The powder flows down through the throat 8 and builds up onto the top of the bottom plate 18 where it takes on an angle of repose and stops flowing. When a vibration is applied to the hopper by a vibration means (not shown), the powder begins to flow out through the mouth 16 and continues flowing while the vibrations continue. The powder deposition rate can be controlled by adjusting the vibration amplitude and frequency, the width of the throat 8, and the mouth 16 opening height. In some embodiments, one or more of these control features are adapted to be remotely or automatically controlled to achieve a desired deposition rate. The deposition rate may be measured by the use of sensors which detect weight of the hopper or by other means so that a feedback loop can be established to maintain or achieve a desired deposition rate. In some embodiments, a portion of the hopper 4 is adapted to contact the deposited powder to smooth and/or compact it as the layer is being formed.

### EXAMPLES

### Example 1

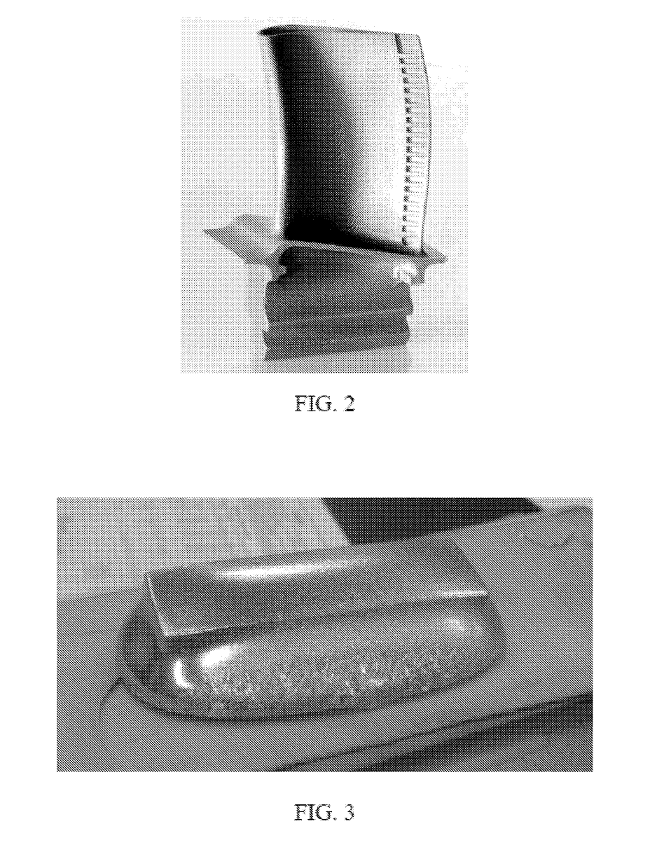

In this example of an embodiment, the powder used was water-atomized nickel-based superalloy of grade IN 625, which had the composition given in Table 1. This powder had a D10 of 6.22 microns, a D50 of 13.92 microns, and a D90 of 26.94 microns as measured by laser diffractometer. A three-dimensional inkjet printer model R2 made by The ExOne Company, North Huntingdon, Pa. 15642 US was used to make a printed article from the powder using a jetted polymeric binder. The printed article had the shape of turbine blades shown in FIG. 2. After printing, the printed article and powder bed in which it was printed was heated to the temperature of 175° C. and held for several hours to cure the binder. After cooling from the curing temperature, the printed article was removed from the powder bed and then heated in a hydrogen atmosphere at a ramp rate of 10° C./minute to a sintering temperature of 1323° C. for one hour, and then cooled to room temperature. The sintered article showed excellent feature definition, i.e. no slumping. The density of the sintered article was determined geometrically from machined portions of the sintered article to be 96.8% dense using a reference density of 8.497 grams/cubic centimeter for the alloy. The amount of liquid phase present in the printed article during sintering was calculated to be 16.3 volume percent using the empirical formula which was derived from the melt volume versus temperature relationship of several nickel-based superalloys:

Volume percent liquid=1.4432e^{4.4091T}

wherein T is the normalized temperature determined as

T=(T_{liquidus}−T₁)/(T_{liquidus}−T_{soludus})

wherein T₁ is the sintering temperature, T_{liquidus} is the liquidus temperature for the alloy, and T_{solidus} is the solidus temperature of the alloy, with all temperatures in ° C. For IN 625, the solidus and liquidus temperatures are generally reported in the literature as being, respectively, 1290° C. and 1350° C., i.e. the conventional melting range for IN 625. It is noted, however, that recently, O. Ozgun et al., Journal of Alloys and Compounds 546 (2013) 192-207, reported the solidus and liquidus temperatures of IN 625 atomized powder as being, respectively, 1298° C. and 1331° C.; using these values, the amount of liquid phase present in the printed article during sintering was 41.2 volume percent.

TABLE 1

| | Water-Atomized Powder |
|---|---|
| Element | (Weight Percent) |
| Nickel | Balance |
| Chromium | 21.72 |
| Molybdenum | 11.20 |
| Niobium | 4.55 |
| Carbon | 0.01 |
| Oxygen | 0.69 |
| Sulfur | 0.003 |
| Nitrogen | 0.08 |

### Example 2

In this comparative example, the water-atomized IN 625 powder and method described in Example 1 were used, except that the sintering temperature was 1315° C. The relative density of the sintered article was measured to be 87.6% and the amount of liquid present was calculated using the conventional IN 625 melting range to be 9.1 volume percent. The sintered article showed excellent feature definition, i.e. no slumping.

### Example 3

In this comparative example gas-atomized IN 625 powder was used with the method described in Example 1, except that the sintering temperature was 1290° C., to make an article in the shape of a block 15.24 cm long by 2.54 cm wide by 2.54 cm high. The chemical analysis of this powder was not available. This powder had a D50 of about 30 microns. The relative density of the sintered article was measured to be 99.2% and the amount of liquid present was calculated using the conventional IN 625 melting range to be 1.4 volume percent. The sintered article showed excellent feature definition, i.e. no slumping.

### Example 4

In this comparative example, the gas atomized IN 625 powder and method described in Example 3, except that the sintering temperature was 1317° C. The relative density of the sintered article was not measured. The amount of liquid present was calculated using the conventional IN 625 melting range to be 10.5 volume percent. The sintered article slumped severely as is evident from FIG. 3.

It should be noted that in the examples described above, the water-atomized powder was finer than the gas-atomized powder. This, too, is contrary to some conventional teachings that the suggest that finer powders have lower melting ranges, as if that were so, the amount of liquid phase present in the water-atomized powders would be even higher than indicated above which would promote rather than hinder slumping.

While only a few embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

What is claimed is:

1. A process for making a nickel-based superalloy article comprising the steps of:
(a) Providing a water-atomized nickel-based superalloy powder;
(b) Depositing a layer of the powder;
(c) Ink jet depositing a binder onto the layer in a pattern that corresponds to a slice of the article;
(d) Repeating the steps (b) and (c) for additional layers of the powder and additional patterns, each of which additional patterns corresponds to an additional slice of the article, until a powder version of the article is completed;
(e) Liquid phase sintering the powder version of the article at a temperature at which at least fifteen volume percent of the powder of the powder version of the article is liquid so as to transform the powder version of the article into the article without slumping;
(f) Cooling the article to solidify the article.

2. The method of claim 1, wherein the nickel-based superalloy is IN 625.

3. The method of claim 1, wherein the solidified article has a relative density of at least 92%.

4. The method of claim 1, wherein the solidified article has a relative density of at least 95%.

5. The method of claim 1, wherein the solidified article has a relative density of at least 98%.

6. The method of claim 1, wherein the solidified article has a relative density of at least 99%.

7. The method of claim 1, wherein step (b) includes using a powder dispenser (2) to deposit the layer, the powder dispenser (2) comprising a hopper (4) including a bottom plate (18) having a top surface with a bevel angle (22) from the horizontal in the range of 5 to 45 degrees.

8. The method of claim 7, wherein the bevel angle (22) is in the range of 5 to 25 degrees.

9. The method of claim 7, wherein the bevel angle (22) is in the range of 10 to 15 degrees.

10. The method of claim 1, wherein the powder has an average particle size of no more than 30 microns.

11. The method of claim 1, wherein the powder has an average particle size of no more than 20 microns.

12. The method of claim 7, wherein the powder has an average particle size of no more than 20 microns.
